(19) United States
(12) Patent Application Publication
(10) Pub. No.: US 2011/0119113 A1
(43) Pub. Date: May 19, 2011

(54) Best Practices for Emission and Energy Management

(75) Inventors: Amit Chatterjee, San Carlos, CA (US); Udo Waibel, Los Altos, CA (US); Jeffrey S. Risberg, Palo Alto, CA (US); James J. Caputo, San Francisco, CA (US)

(73) Assignee: HARA SOFTWARE, INC., Redwood City, CA (US)

(21) Appl. No.: 12/860,843

(22) Filed: Aug. 20, 2010

(51) Int. Cl. G06Q 10/00

(52) U.S. Cl. 705/7.36

(57) ABSTRACT

A centralized emission and energy management system is implemented via a server that is accessible to a client organization. In response to a request to recommend best practices for an organizational unit to reduce environmental impact or energy usage, the system selects relevant best practices based on reduction goals and the organizational unit's particular industry. Based on attribute values for the relevant best practices and the organizational unit, the system filters/ranks the relevant best practices to form recommended best practices. The system may transmit a forecast of energy savings, cost impacts, and environmental impacts over an implementation time period for a draft procedure created from a recommended best practice. The system may generate a request for proposal (RFP) including an approved procedure to a vendor. The system may maintain ratings and feedbacks on the approved procedure and the vendor. The system generally enforces authentication, authorization, and auditing for access to the system.

### FIELD OF INVENTION

This present disclosure is related generally to the field of emissions management, such as greenhouse gas (GHG) emissions management, and more specifically to a centralized emission management system that helps an organization to select best practices for reducing GHG emission.

### DESCRIPTION OF RELATED ART

“Emissions” refer to the introduction of chemicals, particulate matters, biological matters, or other materials into the atmosphere, ground, or water system that potentially can cause harm or discomfort to humans or other living organisms, or may damage the natural environment.

GHG is a collective term for gases such as carbon dioxide, methane, HFCs, SF6, and nitrous oxide that trap heat in the atmosphere and contribute to climate change. GHG accounting and reporting is the discipline of tracking GHGs produced as a result of executing business processes, including manufacturing, travel, keeping of livestock, etc.

The term “carbon dioxide equivalent” (CO2e) is a common normalized unit of measurement, such as expressed in tonnes of CO2e, that is used to compare the relative climate impact of the different GHGs. The CO2e quantity of any GHG is the amount of carbon dioxide that would produce the equivalent global warming potential. There are publicly accepted factors that are used to convert an entity's emissions, usage of resources (e.g., electricity, gas, oil, coal, etc.), or waste products, among other things, into a CO2e emission.

An organization such as a company or a city may want to, or be required to, reduce their CO2e emissions or energy usage. For example, the organization's CO2e emissions may be capped by a governmental or industrial organization within an established time frame. Thus what is needed is a technique to help the organization select practices that best reduce its CO2e emission or energy usage.

### SUMMARY

In one or more embodiments of the present disclosure, a centralized emission and energy management system is implemented via a server that is accessible to a client organization. In response to a request to recommend best practices for an organizational unit to reduce environmental impact or energy usage, the system selects relevant best practices based on reduction goals and the organizational unit's particular industry. Based on attribute values for the relevant best practices and the organizational unit, the system filters/ranks the relevant best practices to form recommended best practices. The system may transmit a forecast of energy savings, cost impacts, and environmental impacts over an implementation time period for a draft procedure created from a recommended best practice. The system may generate a request for proposal (RFP) including an approved procedure to a vendor. The system may maintain ratings and feedbacks on the approved procedure and the vendor. The system generally enforces authentication, authorization, and auditing for access to the system.

### BRIEF DESCRIPTION OF THE DRAWINGS

In the drawings:

FIG. 1 illustrates a web-based environmental and energy management (EEM) system in one or more embodiments of the present disclosure;

FIG. 2 illustrates software modules executed by a server of FIG. 1 in one or more embodiments of the present disclosure;

FIGS. 3A and 3B illustrate a flowchart of a method implementing the EEM system of FIG. 1 to determine best practices for reducing environmental impact in one or more embodiments of the present disclosure;

FIG. 4 shows a graphic user interface (GUI) generated by the server of FIG. 1 for a user to view environmental impact or energy usage reduction plans and associated procedures in one or more embodiments of the present disclosure;

FIG. 5 shows a GUI generated by the server of FIG. 1 for a user to create an environmental impact or energy usage reduction plan in one or more embodiments of the present disclosure;

FIG. 6 shows a GUI generated by the server of FIG. 1 for a user to find recommended best practices in one or more embodiments of the present disclosure;

FIG. 7 shows a GUI generated by the server of FIG. 1 for a user to select a recommended best practice to view its detailed information in one or more embodiments of the present disclosure;

FIG. 8 shows a GUI generated by the server of FIG. 1 for a user to view the detailed information of a selected best practice and to create a draft procedure from the selected best practice in one or more embodiments of the present disclosure;

FIG. 9A shows a GUI generated by the server of FIG. 1 for a user to view a forecast of energy savings, cost impacts, and environmental impacts of a draft procedure over an implementation time period in one or more embodiments of the present disclosure;

FIG. 9B shows a GUI generated by the server of FIG. 1 for a user to view a forecast of a drat procedure in one or more embodiments of the present disclosure;

FIG. 9C shows a GUI generated by the server of FIG. 1 for a user to manage detailed information for a forecast of a draft procedure in one or more embodiments of the present disclosure;

FIGS. 10A and 10B show a GUI generated by the server of FIG. 1 for a user to model combinations of procedures under an environmental impact or energy usage reduction plan in one or more embodiments of the present disclosure;

FIG. 11 shows a GUI generated by the server of FIG. 1 for a user to send a request for proposal to selected vendors in one or more embodiments of the present disclosure; and

FIG. 12 shows a GUI generated by the server of FIG. 1 for a user to edit the definition of a best practice in one or more embodiments of the present disclosure.

Use of the same reference numbers in different figures indicates similar or identical elements.

### DETAILED DESCRIPTION OF THE INVENTION

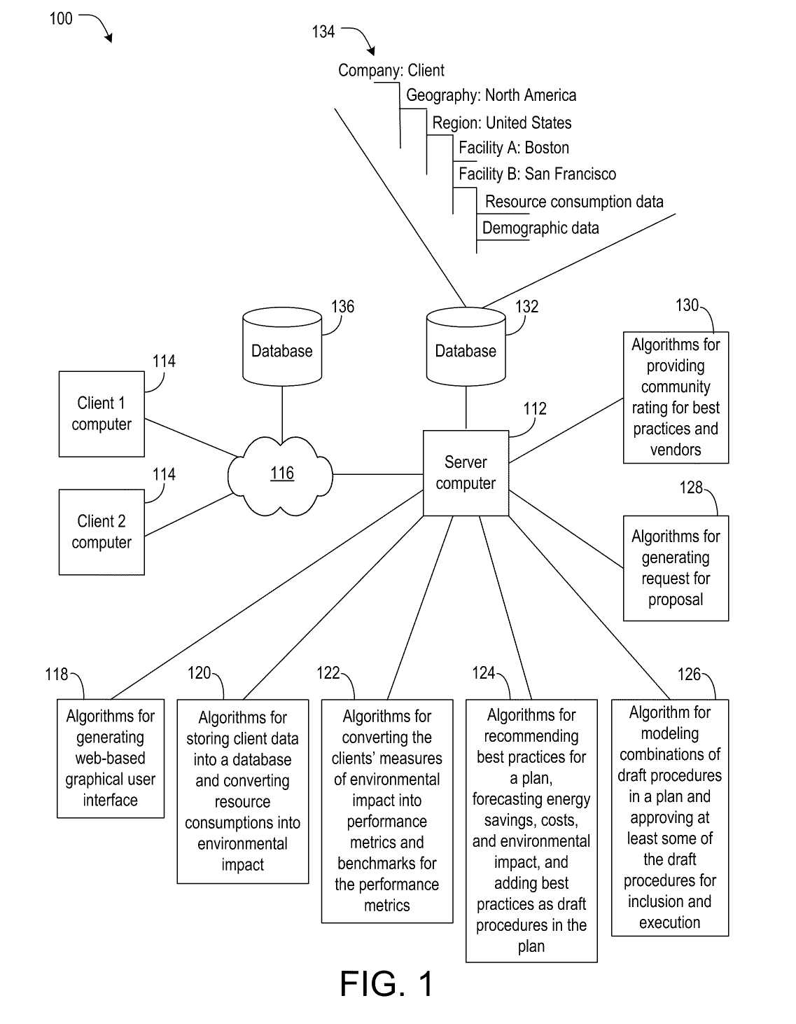

FIG. 1 illustrates a web-based environmental and energy management (EEM) system 100 in one or more embodiments of the present disclosure. A server 112, which may be managed by a host entity, provides a web-based graphical user interface (GUI) that interacts with various client entities to allow the clients to upload data to server 112, view information generated by server 112 related to environmental impact, and allow the clients to interact with the displayed information to develop environmental impact or energy usage reduction plans. Environmental impact includes emission of greenhouse gases and production of wastes such as wastewater. Server 112 and the clients' computers 114 communicate via a public or private computer network 116, such as the Internet.

Although server 112 has many functions, and there may be multiple servers, only one server and its EEM software related to the present disclosure are illustrated. The EEM software includes algorithms 118, 120, 122, 124, 126, 128, and 130, which are stored along with their data in a non-transitory computer-readable medium. Algorithms 118 are for generating the web-based GUI and related functions. Algorithms 120 are for storing the clients' entered data into a database 132 and converting the clients' resource consumptions and other relevant information into CO2e emissions, wastewater production, and other measures of environmental impact. Algorithms 122 are for converting the clients' measures of environmental impact into performance metrics and benchmarks for those performance metrics. Algorithms 124 are for recommending best practices for an environmental impact or energy usage reduction plan, forecasting energy savings, cost impacts, and environmental impacts over time, and adding selected best practices as draft procedures in the environmental impact or energy usage reduction plan. Algorithms 126 are for modeling combinations of draft procedures in an environmental impact or energy usage reduction plan and approving at least some of the draft procedures for inclusion and execution in the plan. Algorithms 128 are for generating a request for proposal (RFP) for an environmental impact or energy usage reduction plan or one or more approved procedures in the plan. Algorithms 130 are for providing community rating of best practices and vendors.

One or more high level employees of a client initially set up the client's account with the EEM software. The high level employees provide part or all of an organizational structure 134 with a hierarchical list of organizational units via the web-based GUI or an upload of a compatible file with such information. The hierarchical levels of the organizational units may be divided into (1) geographical areas such as continents, (2) regions such as countries in a geographical area, and (3) facilities such as buildings in a region. The high level employees assign roles to lower level employees with different levels of authority for the organizational units. The lower level employees input information for the organizational units using the web-based GUI or uploads of compatible files with such information. The EEM software is able to present processed information to the users on a per facility basis or aggregated for different hierarchical levels of the organization.

The client provides information for each organizational unit that is relevant to environmental impact. Some of the information may be related to resource consumption of an organizational unit, such as types of energy used (e.g., electricity, natural gas, diesel, oil, coal, etc.), quantities of energy used (e.g., kwh, gallons, etc.), dates of energy used, costs of energy used, airline travel, lighting usage, types/amounts of products manufactured and types/amounts of emissions, efficiencies, waste products, water usage, raw input product usage (e.g., paper, metals, etc.), costs of various pertinent resources, and other types of data pertinent to resource consumption. Server 112 saves the individual resource consumption entries as resource consumption items for the organizational unit in database 132. Some of the information may be related to demographics of the organizational unit, such as facility area (e.g., square footage), facility revenue, facility produced units, facility type (e.g., office, manufacturing, etc.), facility age, facility operating hours, facility employee count, facility HVAC type, facility location, and other types of data pertinent to demographics.

Each input resource and/or output product, assuming a certain usage efficiency, is applied to an appropriate algorithm 120 to determine its corresponding CO2e emission quantity or other measures of environmental impact. Many of the algorithms 120 correlating resources, outputs, or activities to an equivalent CO2e emission are based on publicly known standards, such as the Emissions & Generation Resource Integrated Database (eGRID) conversion factors used by the Environmental Protection Agency (EPA).

The raw data, e.g., in kilowatt-hours of electricity, therms of natural gas or gallons of gasoline, is periodically input by the clients, such as at the end of each accounting period, which may be yearly. The client's data may also include information that is automatically uploaded to the server 112 through any interface, such as a utility meter for electricity, water, etc. Server 112 stores the past data in database 132. Server 112 processes the data and presents the processed data to the client in a suitable presentation on the web-based GUI, upon the client requesting the presentation.

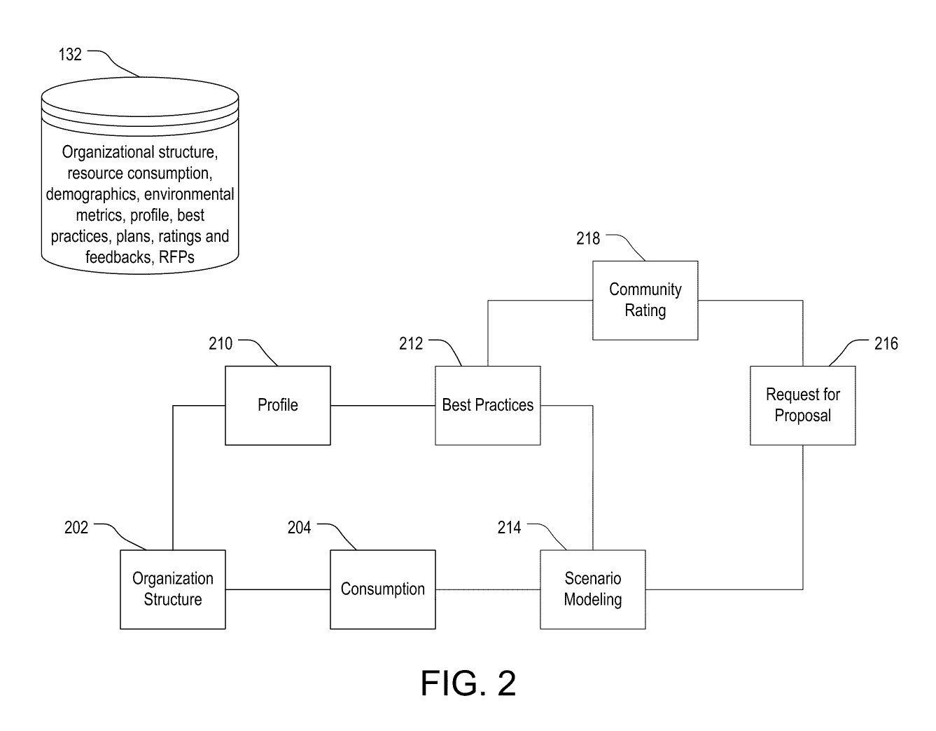

FIG. 2 illustrates software modules implementing algorithms 120 to 130 executed by server 112 of FIG. 1 in one or more embodiments of the present disclosure. An organizational structure module 202 stores client organization structures and their demographic and resource consumption data in database 132. A consumption module 204 determines resource consumptions and environmental impacts from demographic and resource consumption data in database 132. Consumption module 204 uses a set of common conversion factors (e.g., the kilograms of carbon that correspond to the usage of kilowatt-hours of electricity) in database 132 in its calculations for consistency within and between clients.

A profile module 210 queries attributes for recommending best practices to reduce environmental impact. Profile module 210 stores the attributes in database 132. A best practices module 212 uses attributes to recommend best practices, provide forecasts of energy savings, cost impacts, and environmental impacts, and selects best practices as draft procedures in an environmental impact or energy usage reduction plan. Best practices module 212 uses the set of common conversion factors in database 132 in its calculations.

A scenario modeling module 214 models combinations of draft procedures in an environmental impact or energy usage reduction plan and allows approval of procedures for inclusion and execution to maximize environmental impact reduction or energy savings while minimizing cost impacts. Scenario modeling module 214 use the set of common conversion factors in database 132 in its calculations. An RFP module 216 generates RFP to vendors for an environmental impact or energy usage reduction plan or one or more approved procedures in the plan. A community rating module 218 maintains a rating system for practices and vendors based on ratings and feedbacks from the clients.

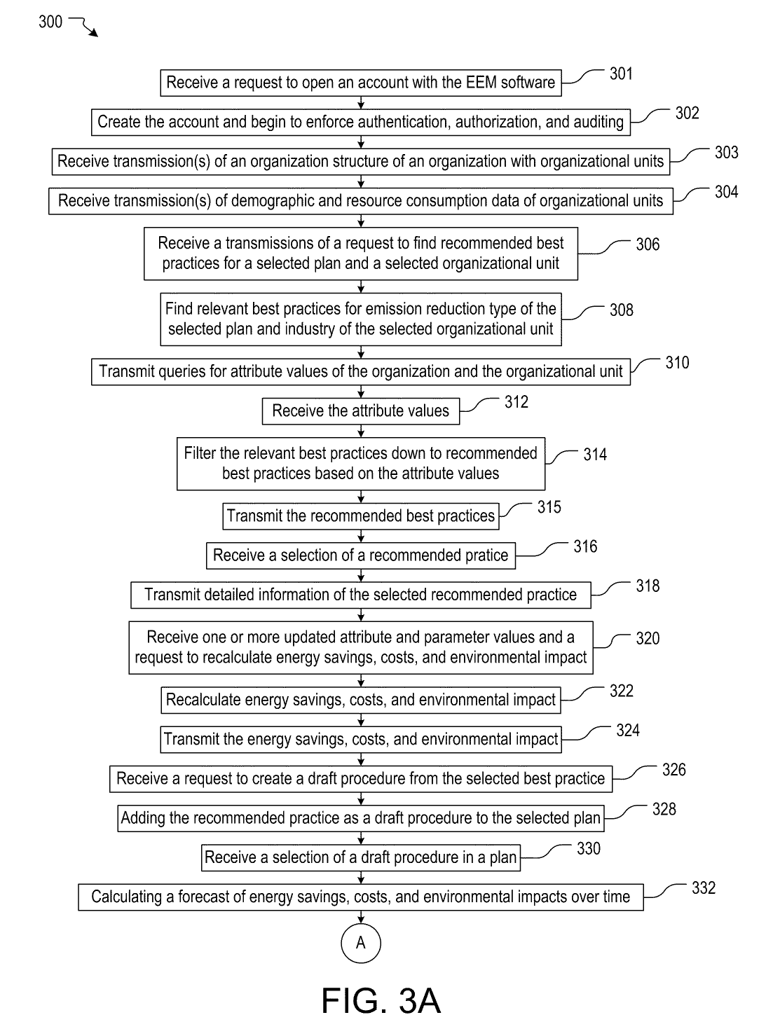

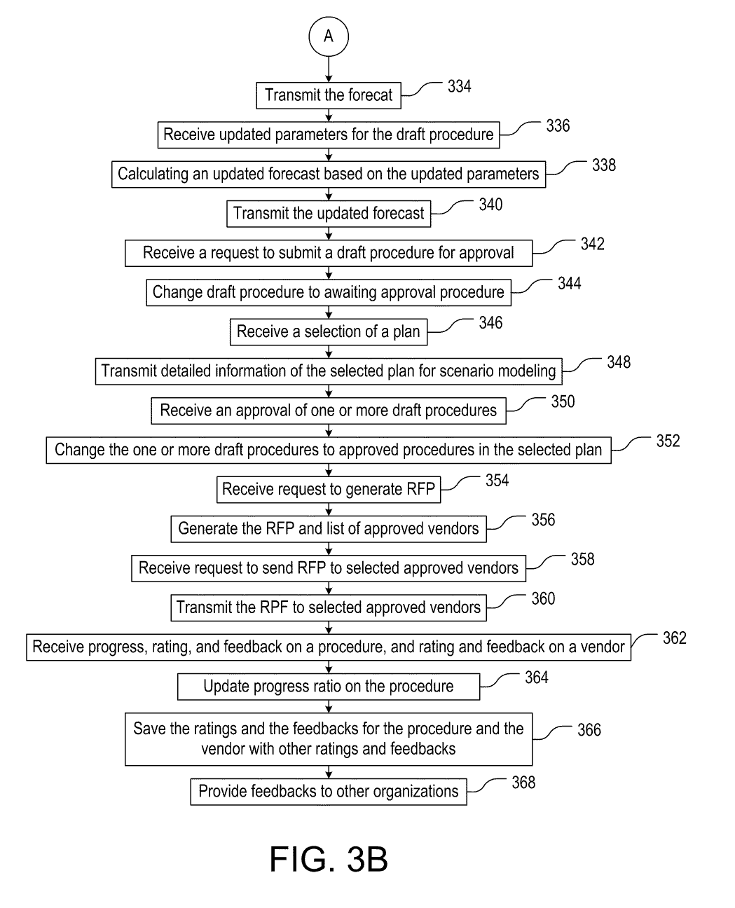

FIG. 3 is a flowchart of a method 300 executed by one or more processors in server 112 in FIG. 1 to help a client reduce environmental impact in one or more embodiments of the present disclosure. Method 300 may comprise one or more operations, functions or actions as illustrated by one or more of blocks. Although the blocks are illustrated in a sequential order to demonstrate the EEM software, these blocks may also be performed in parallel, and/or in a different order than those described herein. Also, the various blocks may be combined into fewer blocks, divided into additional blocks, and/or eliminated based upon the desired implementation.

Method 300 may begin in block 301. In block 301, server 112 receives from the client a request to open an account with the EEM software. The client may be a company, a city, an educational institution, or any other type of organization. The client may be represented by one or more employees at one or more client's computers 114.

In block 302, server 112 creates the account and begins to enforce authentication, authorization, and auditing on the account. For example, server 112 only allows access to the account after each user provides the proper username and password, the server only authorizes each user to access information specified for the user, and the server records each user's activities to provide an audit trail. The users may be the client's employees, contractors, vendors, and customers.

In block 303, server 112 receives from the client the client's organization structure. The organization structure is a hierarchical list of the client's organizational units. Server 112 also receives definitions of users and their roles for the organizational units. The roles of the users define the ability of the users to view and make changes to the organizational units.

In block 304, server 112 receives from the client demographic data and resource consumption data of the organizational units. These data are accumulated over time by server 112. The types of demographic data may include, but are not limited to, facility type, facility area, facility revenue, facility produced units, facility age, facility operating hours, facility employee count, facility HVAC type, and facility location. The types of resource consumption data may include but are not limited to resource consumption types, resource consumption amounts, dates of consumption, indications if information for each resource consumption item is estimated by the client, and resource consumption prices. Server 112 calculates the client's measures of environmental impact from these data, such as CO2e emission and waste production. Server 112 stores the measures of environmental impact in database 132.

After the client sets up its account and uploads sufficient information about its organization, the client may use the EEM software to devise environmental impact or energy usage reduction plans, also known as strategies. An environmental impact or energy usage reduction plan is a program with goals, a budget, and an implementation time period. An environmental impact or energy usage reduction plan consists of procedures, also known as initiatives, selected to satisfy the plan's goals. A procedure is created from one of the best practices provided in the EEM software or it is suggested by a stakeholder in the environmental impact or energy usage reduction plan as described later. A best practice is a customizable tactic for reducing environmental impact or reducing energy usage.

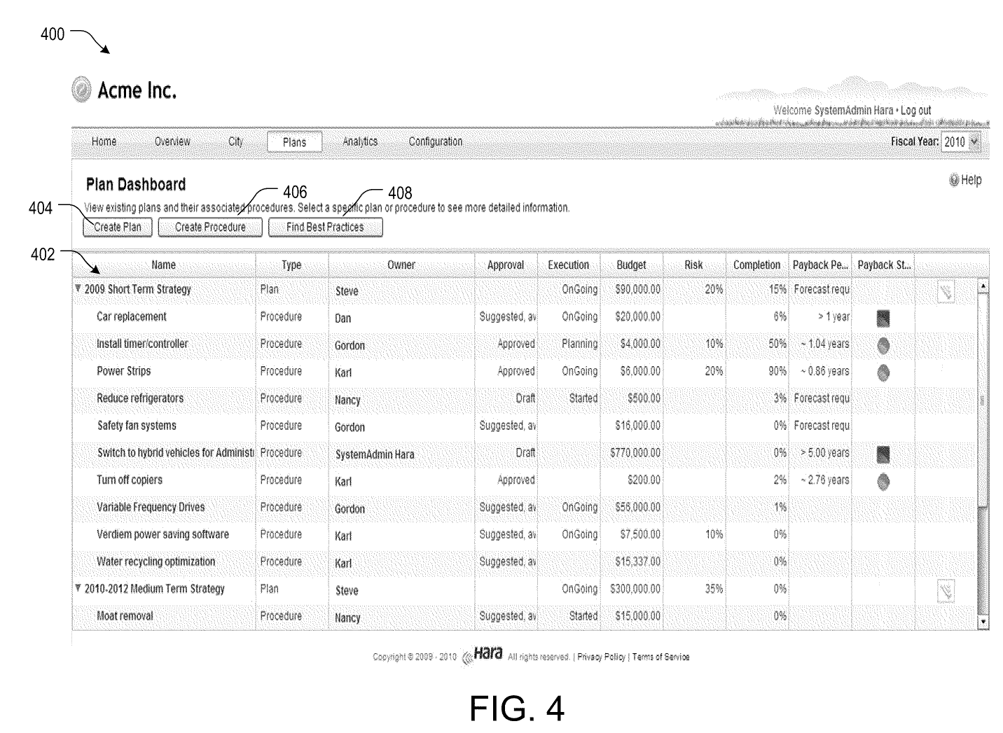

The client navigates to an illustrative GUI 400 in FIG. 4, generated by server 112, to view existing environmental impact or energy usage reduction plans and associated procedures. GUI 400 provides an overview 402 of the existing plans and the associated procedures. Each of the plans and the procedures is listed as a line item, and each line item includes a name, a type, an owner, an approval status, an execution status, a budget, a risk factor, a completion ratio, a payback period, and a payback status. The owner identifies the user that created the line item. Only the owner and those assigned by the owner, also known as stakeholders, may edit the line item. The approval status indicates if a procedure is a draft procedure, a “suggested, awaiting approval” procedure, or an approved procedure. A procedure that is “suggested, awaiting approval” is one that has been proposed by a stakeholder for an environmental impact or energy usage reduction plan but has not been approved or rejected by the plan owner. For example, there may be a plan to reduce electricity usage in all U.S. facilities owned by the vice-president of U.S. Operations, and a stakeholder (such as an individual facility manager) may suggest installing lighting occupancy sensors at his facility as a procedure that will help satisfy the goals of this plan. This suggestion may or may not be based on one of the best practices provided in the EMM software. The strategy owner may then use scenario modeling to decide if this procedure is worth approving or should be rejected. The risk factor indicates a multiplier applied to the calculations for a line item to account for the risk involved in that line item.

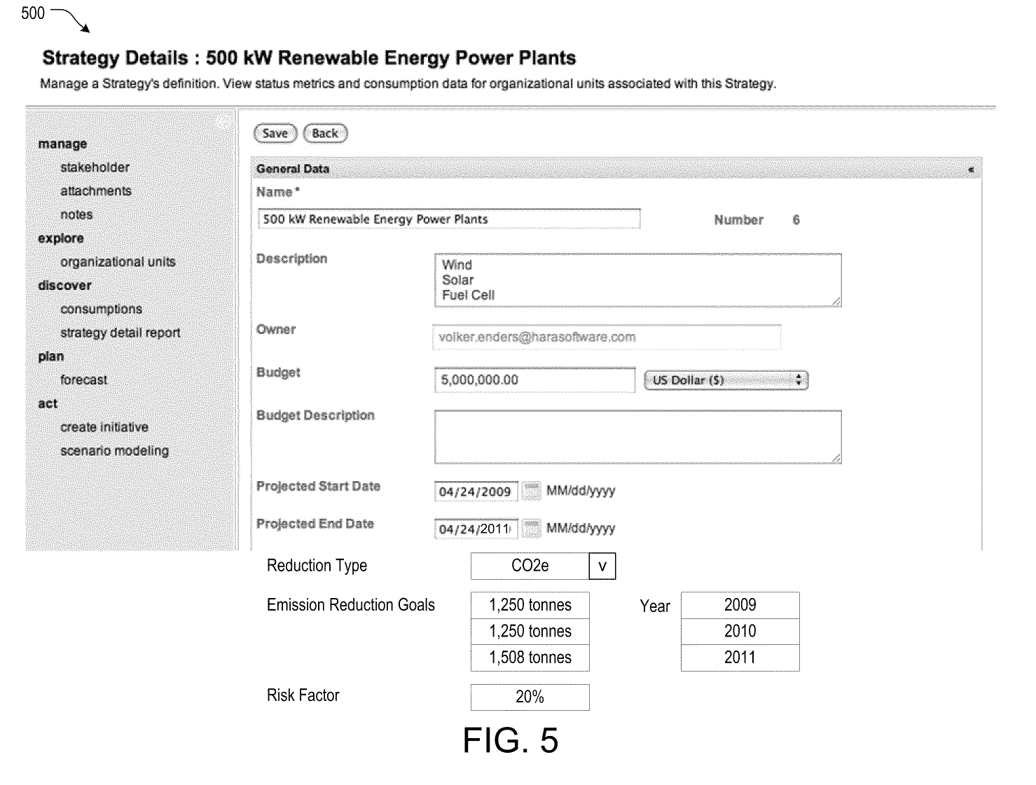

The client may select a create plan button 404 to create a new environmental impact or energy usage reduction plan. In response, server 112 generates an illustrative GUI 500 of FIG. 5 for the client to provide a name, a description, an owner, a budget, a budget description, an implementation time period, an environmental impact or energy usage reduction type, reduction goals over time, and a risk factor for the plan. Types of environmental impact or energy usage reduction include reduction of waste product such as wastewater and CO2e emission, and reduction of resource consumption such as electricity and fossil fuels. The client may add multiple reduction types and set their goals over the implementation time period. The goals may vary over the implementation time period.

Referring back to FIG. 4, the client may select a create procedure button 406 to create a procedure for an environmental impact or energy usage reduction plan and an organizational unit. These procedures are collected within the plan. In response, server 112 generates a GUI for the client to select an environmental impact or energy usage reduction plan, to select an organizational unit, and to create a draft procedure for the selected plan. This may be performed without any recommendations for best practices from server 112.

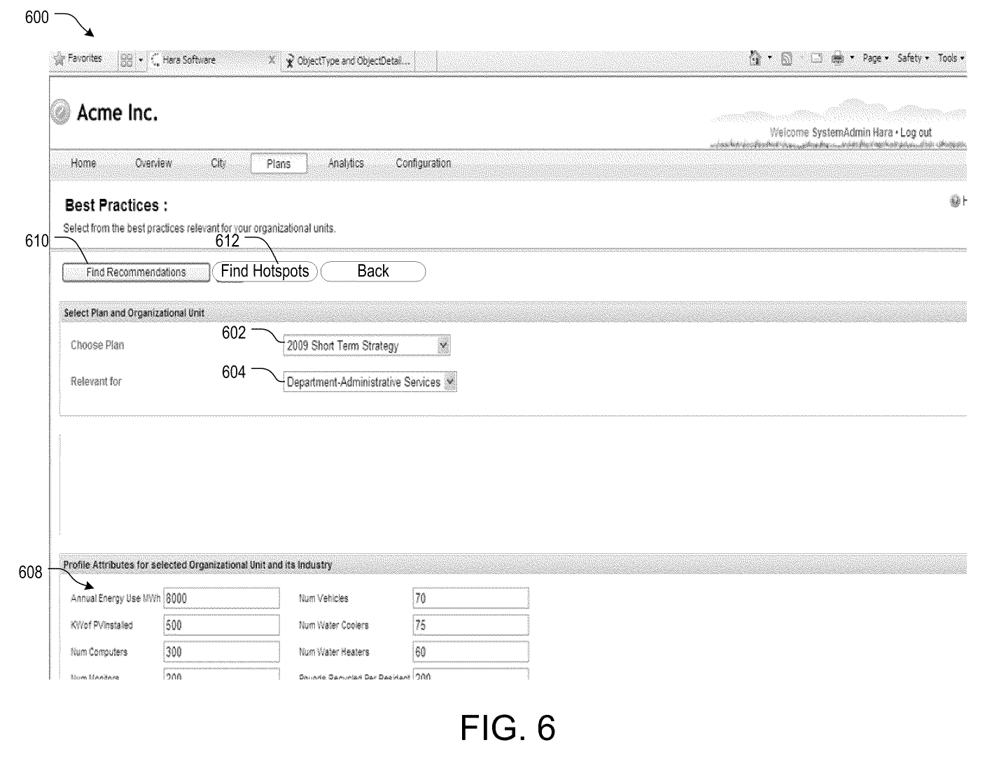

The client may select a find best practice button 408 to find best practices for an environmental impact or energy usage reduction plan and an organizational unit. In response, server 112 generates an illustrative GUI 600 of FIG. 6 for the client to provide information used by the server to recommend best practices. The client may also navigate to GUI 600 from elsewhere within the EEM software. For example, button 408 may appear in a GUI for the client to view resource consumptions by an organizational unit.

GUI 600 includes a dropdown list 602 for the client to select an existing environmental impact or energy usage reduction plan, and a dropdown list 604 for the client to select an organizational unit. Based on the selected plan and the selected organizational unit, server 112 determines relevant best practices for the selected organizational unit. Specifically, server 112 find best practices that can address the environmental impact or energy usage reduction types of the selected plan and the industry of the selected organizational unit. Server 112 categorizes the best practices by the reduction types and the industries they can address in database 132. Server 112 may ask the client to provide additional information for determining the relevant best practices.

GUI 600 further includes queries for attributes of the relevant best practices. Server 112 uses attribute values provided by the client to calculate preliminary energy savings, cost impacts (including a payback period), and environmental impacts. Server 112 may also use the attributed values to further filter and rank the relevant best practices to form recommended best practices. The relevant best practices may be filtered by the presence of certain attributes, such as equipment at a facility. For example, some best practices apply when roof space is available, windows can be replaced, or the building is in a geographic region with the needed level of solar exposure. The relevant best practices may be ranked by factors determined from the attributes, such as the total emission reductions, the payback periods, or the total energy savings.

The attributes include profile attributes 608. Profile attributes 608 are local attributes of the selected organizational unit. The client provides the attribute values and then selects a find recommendations button 610. Server 112 saves the attribute values in database 132 so the server can automatically populate any GUI with the relevant attribute values. When any of the attribute values are available from the demographic and the resource consumption data in database 132, server 112 may automatically populate them in GUI 600. The client may edit these attribute values and server 112 propagates the changes to their sources in database 132.

GUI 600 may include a find hotspot button 612, which the client selects to find underperforming organizational units that are good candidates for best practices to reduce environmental impact. In response, server 112 compares the performances of all the organizational units against benchmarks to identify the underperforming organizational units. The generation of benchmarks is described in U.S. patent application Ser. No. 12/748,084, filed Mar. 26, 2010, entitled “System Generated Benchmarks,” which is commonly assigned and incorporated by reference. The server 112 may transmit to the client a list of the underperforming organizational units or automatically find relevant best practices for them. Alternatively find hotspot button 612 is located on another GUI, such as its only dedicated GUI.

Referring back FIG. 3A, in block 306, assume server 112 receives from the client a request to find best practices for a selected environmental impact or energy usage reduction plan and a selected organizational unit.

In block 308, server 112 find relevant best practices that can address the reduction goals of the selected plan and the industry of the selected organizational unit. Server 112 also gathers the attributes for the relevant best practices.

In block 310, server 112 transmits to the client queries for attribute values for the relevant best practices.

In block 312, server 112 receives from the client the attribute values for the relevant best practices. Server 112 uses the attributed values to further filter and rank the relevant best practices to form recommended best practices.

In block 314, server 112 calculates preliminary energy savings, cost impacts, and environmental impacts for the recommended best practices in one year based on the attribute values. For some best practices, server 112 also uses default values for parameters of those best practices to calculate preliminary energy savings, cost impacts, environmental impacts, and payback periods. The client may later edit the parameter values and the attribute values to recalculate the energy savings, the cost impacts, and the environmental impacts. Server 112 also determines how many times the recommended best practices have been referenced (i.e., used as a draft procedure) and used by any client in the EEM software.

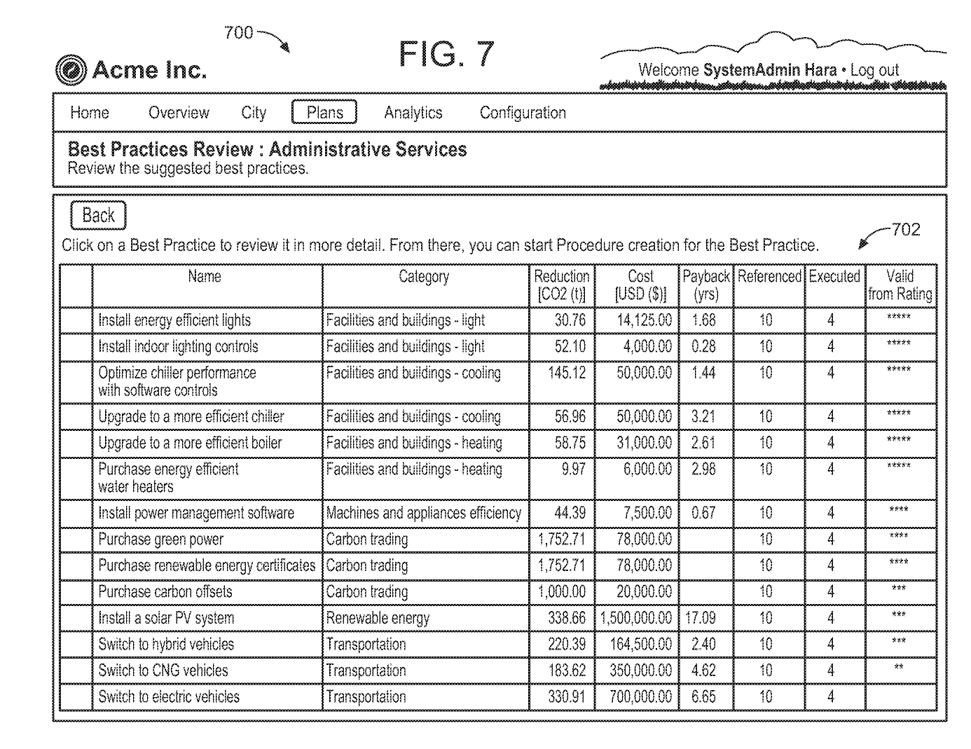

In block 315, server 112 transmits to the client the recommended best practices in an illustrative GUI 700 in FIG. 7. GUI 700 provides an overview 702 of the recommended best practices. Each best practice is listed as a line item, and each line item includes a name, a best practice category, a reduction in environmental impact, a cost, a payback period, a number of times the best practice has been referenced, a number of times the best practice has been used, a valid usage period, and a community rating. The client may select a recommended best practice to review the recommended best practice in more detail and create a draft procedure for the selected plan.

Referring back to FIG. 3A, in block 316, assume server 112 receives from the client a selection of a recommended best practice.

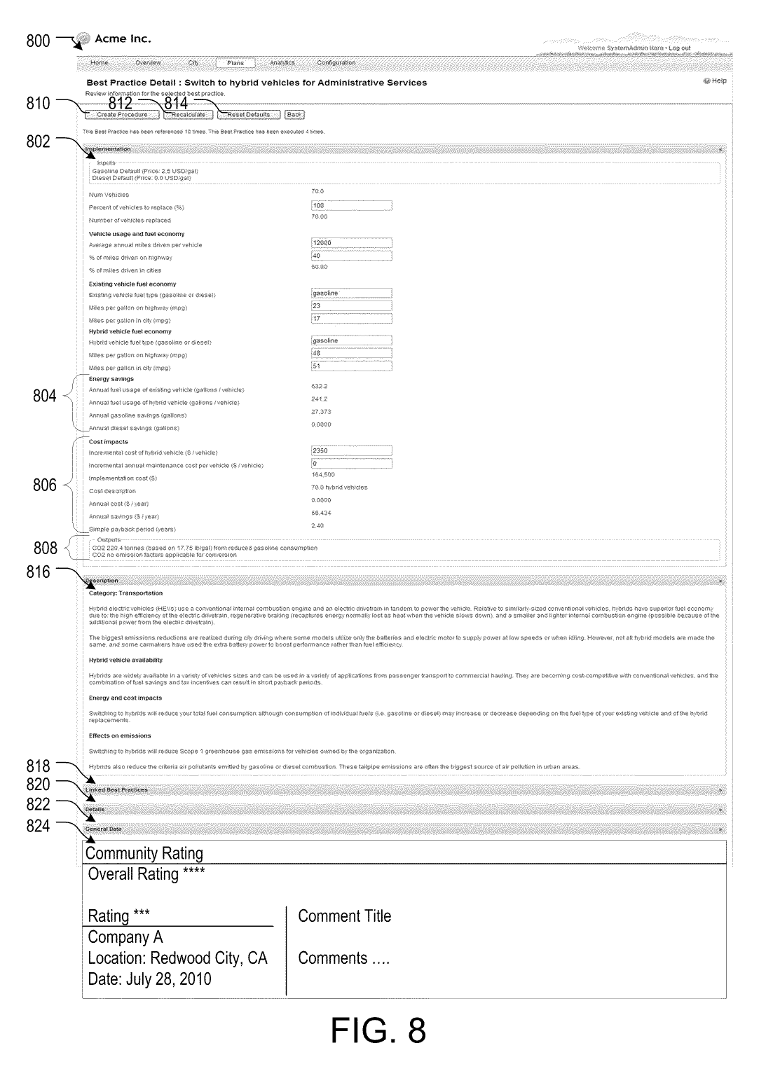

In block 318, server 112 transmits to the client detailed information for the selected best practice in an illustrative GUI 800 in FIG. 8. GUI 800 provides an implementation section 802 providing energy savings 804, cost impacts 806, and environmental impacts 808 for the selected best practice based on the attributes previously provided by the client and default parameter values for the selected best practice. GUI 800 also includes a description section 816 providing a description of the selected best practice, a linked practices section 818 (not expanded) providing links to related best practices, a details section 820 (not expanded), a general data section 822 (not expanded), and a community rating section 824 providing specific ratings and feedbacks by other clients on the selected best practice. Details section 820 provides links to external references related to implementing the selected best practice or examples of other organizations that have implemented it. For example, many best practices include descriptive links to relevant Environmental Protection Agency documents and data. General data section 822 shows when the selected best practice was last updated and the user that last updated the selected best practice if the selected best practice has been changed.

The client may select a create procedure button 810 to create a draft procedure from the selected best practice. The client may also edit the attribute values and the default parameter values in implementation section 802 and then select a “recalculate” button 812 to recalculate energy savings 804, cost impacts 806, and environmental impact 808. Server 112 saves the attribute and the parameter values in database 132 so the server can automatically populate any GUI with the attribute and the parameter values. The client may select a “reset defaults” button 814 to restore the default parameter values.

Referring back to FIG. 3A, in block 320, assume server 112 receives from the client one or more updated attribute and parameter values for the selected best practice and a request to recalculate energy savings 804, cost impacts 806, and environmental impacts 808.

In block 322, server 112 recalculates energy savings 804, cost impacts 806, and environmental impact 808 for the selected best practice based on the updated attribute and parameter values.

In block 324, server 112 retransmits to the client energy savings 804, cost impacts 806, and environmental impacts 808 for updating GUI 800 in FIG. 8.

In block 326, assume server 112 receives from the client a request to create a draft procedure from the selected best practice with the attribute and the parameter values.

In block 328, server 112 adds the selected best practice with the attribute and the parameter values as a draft procedure to the selected plan. Each draft procedure has to be approved through scenario modeling, described later, before it is executed.

The above blocks may be repeated for the client to add more draft procedures to the selected plan. The client may then navigate back to GUI 400 of FIG. 4 for the client to select a draft procedure for review and approval.

In block 330, assume server 112 receives a selection of a draft procedure in an environmental impact or energy usage reduction plan.

In block 332, server 112 calculates a forecast of energy savings, costs, and environmental impact of the selected draft procedure over the time period for the environmental impact or energy usage reduction plan based on the attribute and the parameter values of the selected draft procedure.

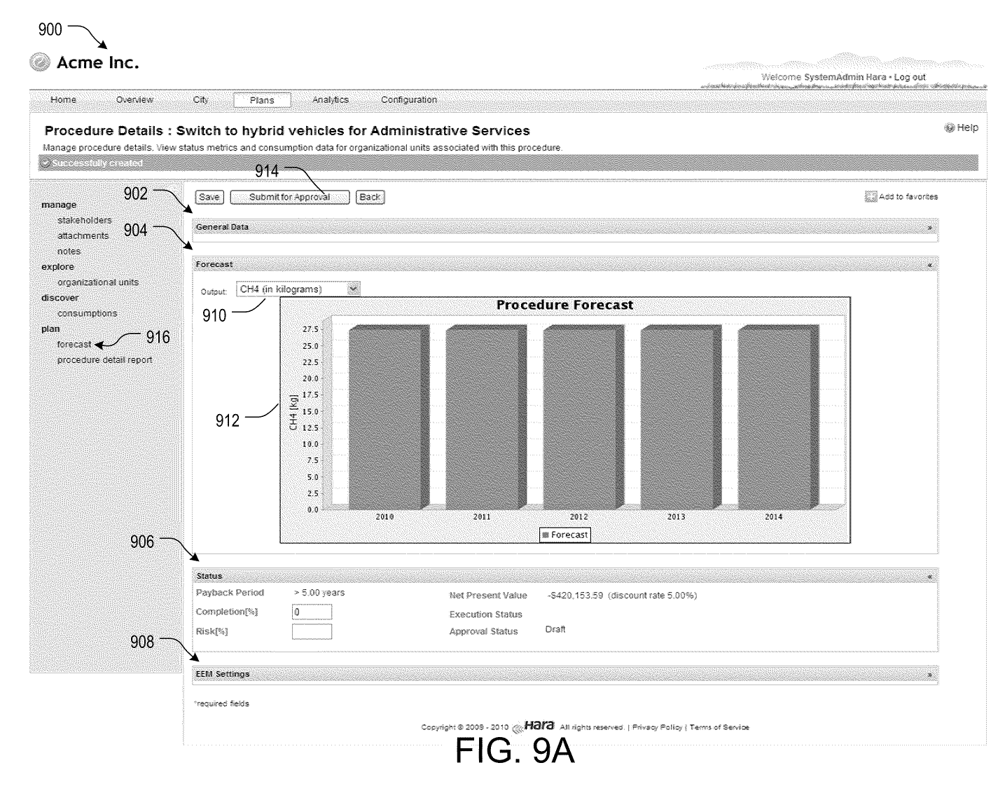

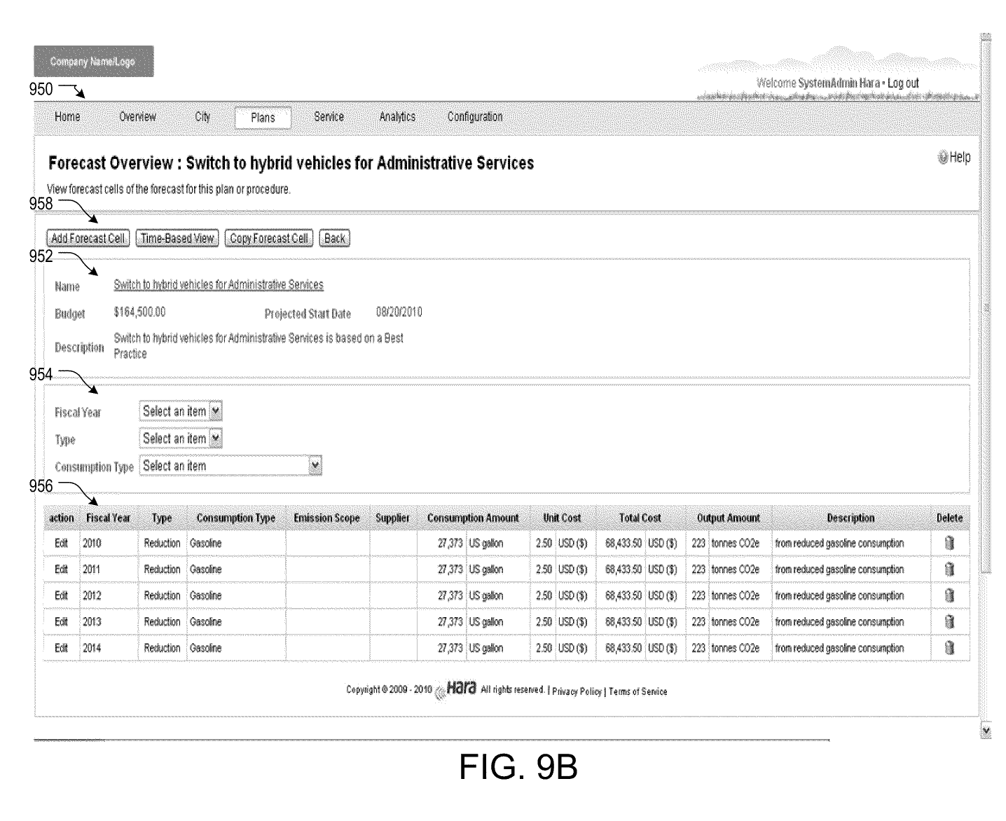

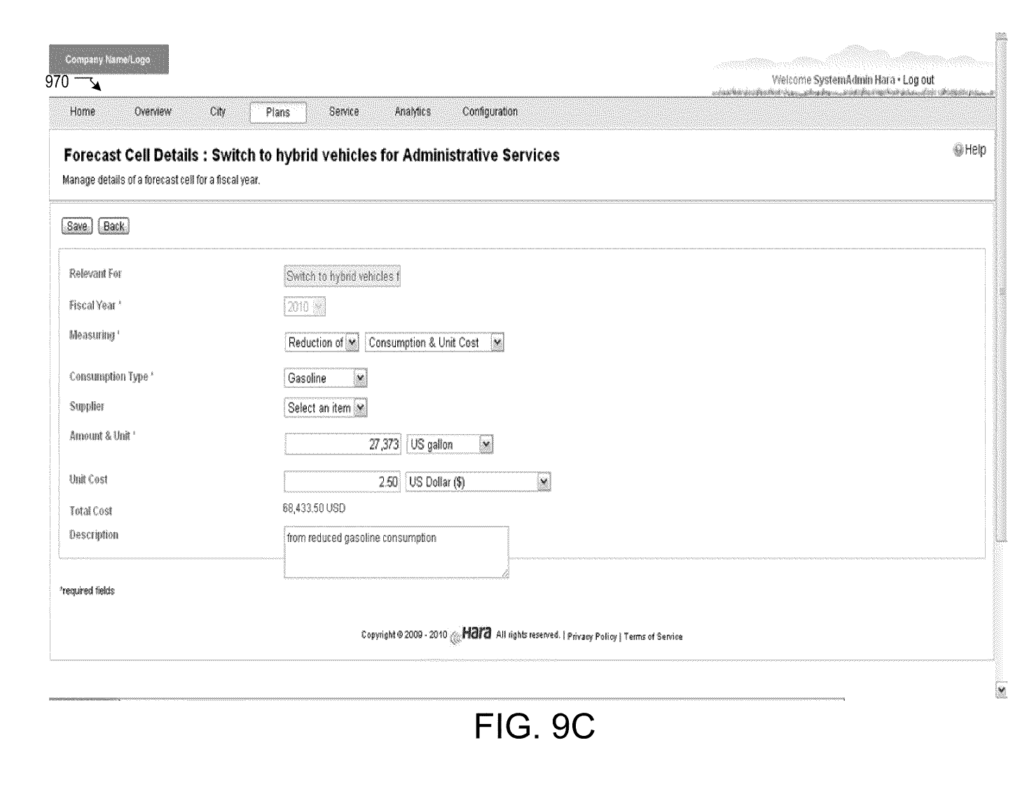

Referring to FIG. 3B, in block 334, server 112 transmits the forecast. The forecast may take the form of an illustrative GUI 900 in FIG. 9. GUI 900 includes a general data section 902, a forecast section 904, a status section 906, and an EEM setting section 908. General data section 902 includes basic description about the draft procedure. Forecast section 904 includes a dropdown list 910 to select a forecast type, and a chart or table 912 representing the forecast. The forecast type includes energy savings, cost impacts, and environmental impacts. Status section 906 indicates a payback period, a completion ratio, a risk factor, a net present value, an execution status, and an approval status of the selected draft procedure. EEM setting section 908 show audit trail information, such as the user that last updated the selected draft procedure.

After viewing GUI 900, the client may wish to edit the forecast in forecast section 904. The client may select a link or button 916 to edit the forecast. In response, server 112 transmits to the client a forecast overview in an illustrative GUI 950 in FIG. 9B. GUI 950 includes a general description section 952, a filter section 954, and a forecast section 956. General description section 952 includes the draft procedure name, the budge, the projected start data of the draft procedure, and a general description of the draft procedure. Each row of forecast section 956 includes the fiscal year, the reduction type, the consumption type, and the attribute and the parameter values for that row of the forecast. The client may select an add forecast cell button 958 to bring up another GUI to add a new column of forecast cells of an attribute or parameter to the forecast rows. The client may use filter section 954 to filter out the forecast rows in forecast section 956. The client may select a time-base view button 960 to rearrange each forecast cell type by time in forecast section 956

The client may select to edit a row in forecast section 956 in GUI 950. In response, server 112 transmits the client an illustrative GUI 970 in FIG. 9C for the client to edit the attribute and the parameter values used to generate the selected row in forecast 956. After making edits in GUI 970 in FIG. 9C, the client may see how the changes affect the forecast in GUI 950 in FIG. 9B or GUI 900 in FIG. 9A.

Server 112 saves the updated attribute and the parameter values in database 132 so the server can automatically populate any GUI with the relevant attribute and the parameter values. The client may select a submit for approval button 914 to submit the selected draft procedure for approval.

Referring back to FIG. 3B, in block 336, assume server 112 receives from the client one or more updated attribute and parameter values as described above with respect to GUI 970 in FIG. 9C.

In block 338, server 112 recalculates the forecast of the energy savings, the cost impacts, and the environmental impacts for the selected draft procedure over time with the updated attribute and parameter values.

In block 340, server 112 transmits to the client the updated forecast for GUI 950 in FIG. 9B or GUI 900 in FIG. 9A.

In block 342, assume server 112 receives from the client a request to submit the draft procedure for approval as described above with respect to GUI 900 in FIG. 9.

In block 344, server 112 changes the status of the procedure from draft to awaiting approval.

The above blocks may be repeated for the client to add more awaiting approval procedures to the environmental impact or energy usage reduction plan. Once the client has added a desired number of awaiting approval procedures to the environmental impact or energy usage reduction plan, the client may select the plan from GUI 400 in FIG. 4 for scenario modeling the plan and approve a combination of the procedures for inclusion and execution in the plan. Note that it is likely not the same user submitting the draft procedures for approval and approving them. The EEM software allows for this division of responsibility and will enforce it if configured that way.

In block 346, assume server 112 receives from the client a selection of an environmental impact or energy usage reduction plan.

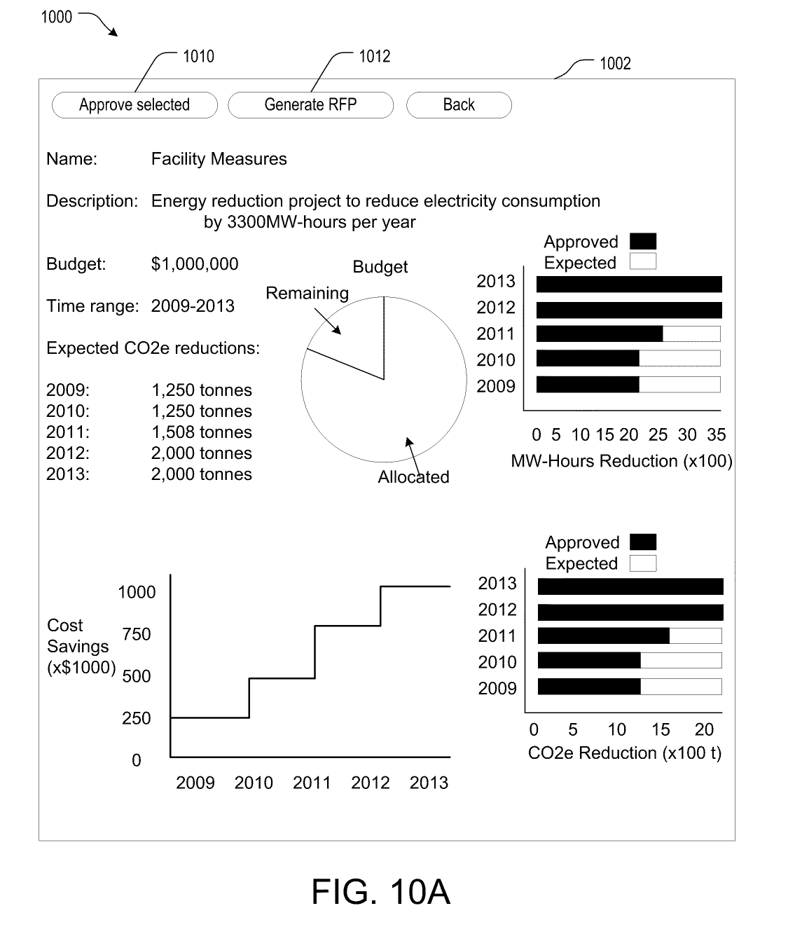

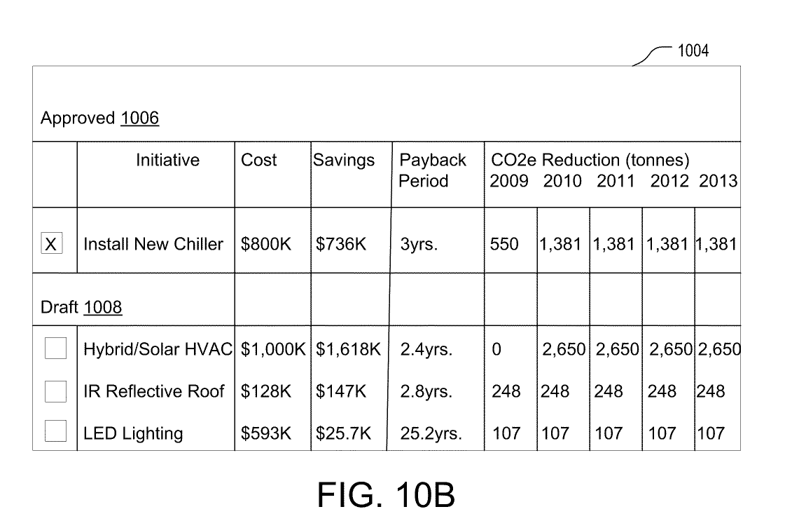

In block 348, server 112 transmits to the client the detailed information of the selected plan for scenario modeling in an illustrative GUI 1000 in FIGS. 10A and 10B.

GUI 1000 includes a detailed section 1002 in FIG. 10A that provides information such as a name, a description, a budget, a time period, reduction goals over the time period, a chart showing allocated and remaining portions of the budget, a chart showing energy savings from approved procedures compared to their goals, a chart showing cost impacts over the time period, and a chart showing environmental impact or energy usage reductions from approved procedures compared to their goals. Instead of the information shown, the client may identify other information to be provided by server 112

GUI 1000 further includes a procedure section 1004 in FIG. 10B with an approved procedure subsection 1006 and a draft procedure subsection 1008. Each procedure is listed as a line item with a name, a cost, a cost savings, a payback period, and environmental impact reductions or energy savings over the time period.

Initially, there are only draft procedures awaiting approval under draft procedure subsection 1008. Once a draft procedure is approved, server 112 moves it to approved procedure subsection 1006 for inclusion and execution in the environmental impact or energy usage reduction plan. The client may select any combination (a subset) of the draft procedures by selecting their check boxes for scenario modeling. In response, server 112 revises the charts shown in detailed section 1002 of FIG. 10A to show the effects of the combination of the selected draft procedures along with any approved procedures.

If the client, based on the result of the scenario modeling, wishes to approve a combination of selected draft procedures, the client selects an approve selected button 1010 in FIG. 10A to move the selected draft procedures into approved procedure subsection 1006 as approved procedures. The client may approve additional draft procedures until the environmental impact or energy usage reduction goals are met. The client may uncheck any approved procedures in approved procedure subsection 1006 and then select approve selected button 1010 to move the unchecked approved procedures back into draft procedure subsection 1008 as draft procedures.

Referring back to FIG. 3B, in block 350, assume server 112 receives from the client an approval of one or more draft procedures as described above with respect to GUI 1000 in FIGS. 10A and 10B.

In block 352, server 112 changes the one or more draft procedures to one or more approved procedures in the environmental impact or energy usage reduction plan.

After the user has completed an environmental impact or energy usage reduction plan, the user may select a generate RFP button 1012 on detailed section 1002 of FIG. 10A to use the EEM software to generate a RFP and select vendors to receive the RFP. The client may select to generate the RFP for the entire environmental impact or energy usage reduction plan or a subset of approved procedures under the plan.

Referring back to FIG. 3B, in block 354, assume server 112 receives from the client a request to generate a RFP for an environmental impact or energy usage reduction plan or a subset of approved procedures under the plan as described above with respect to GUI 1000 in FIGS. 10A and 10B.

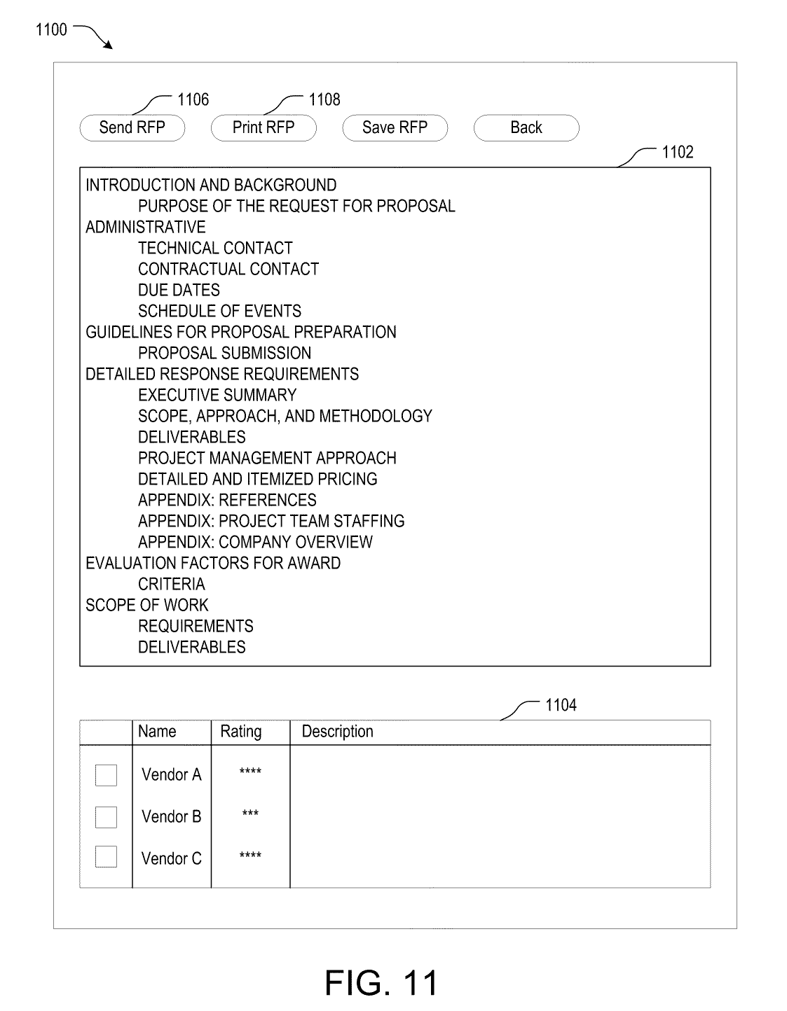

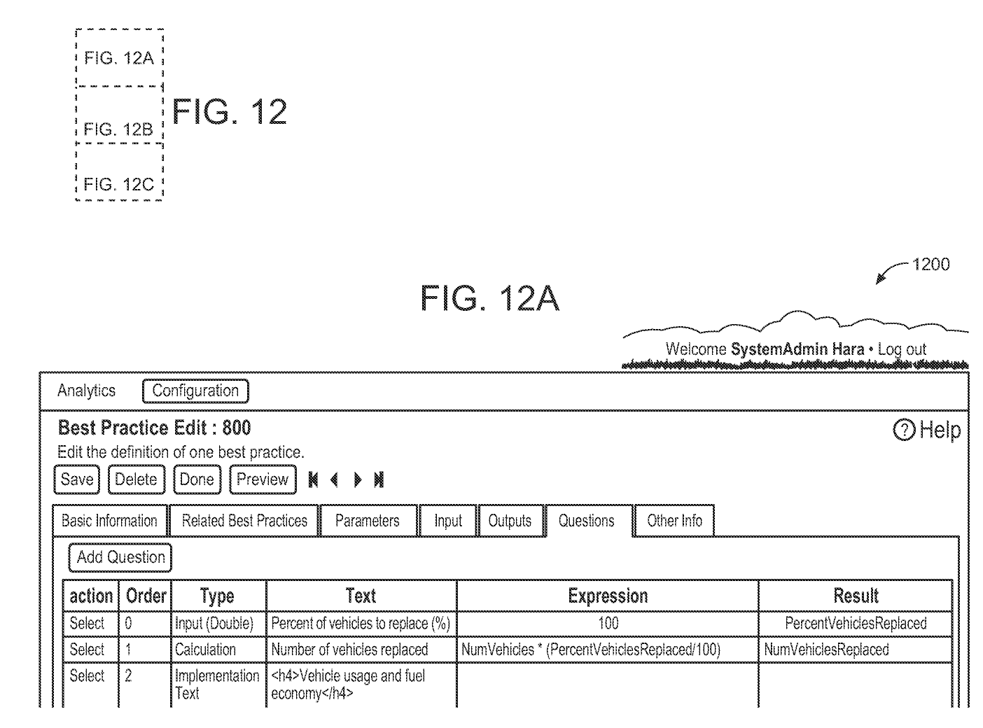

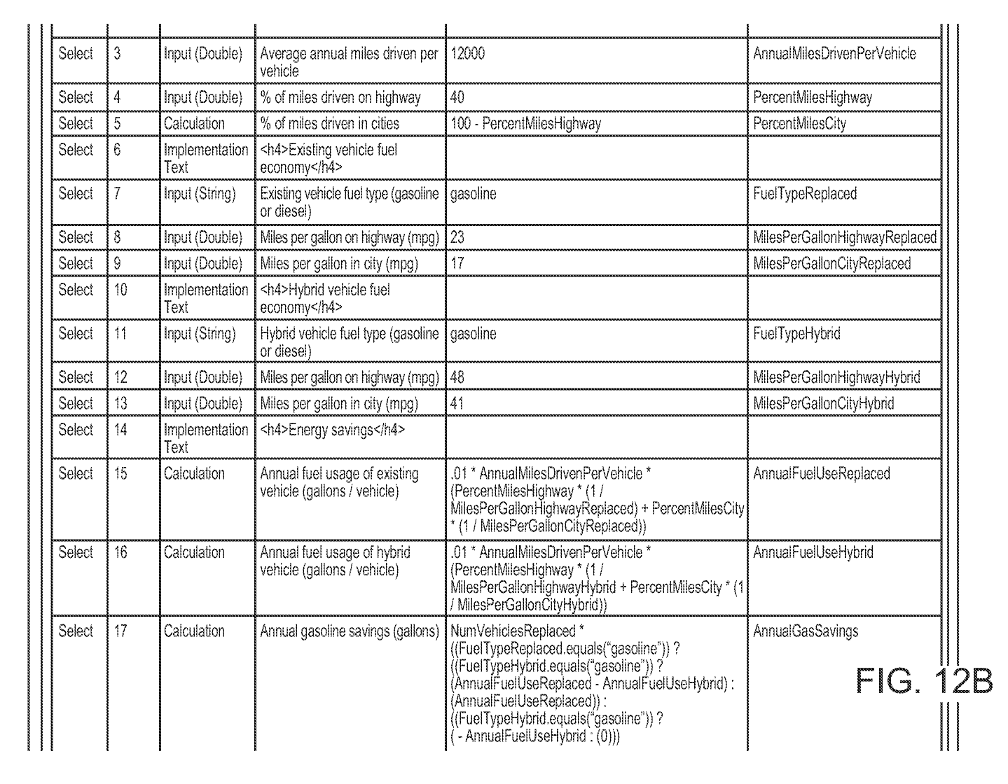

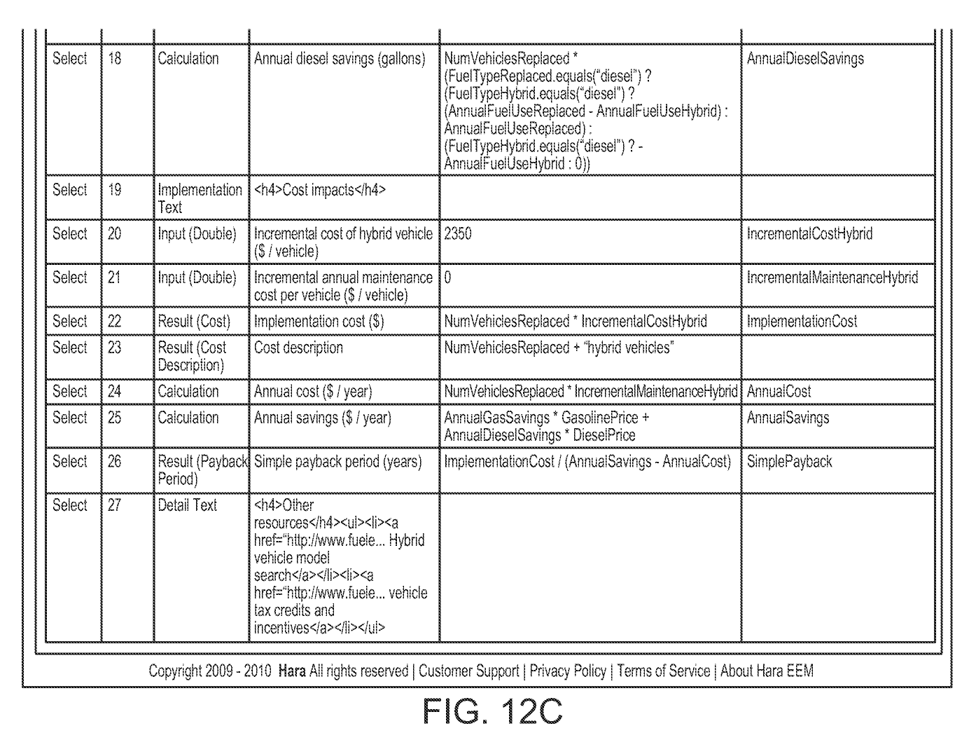

In block 356, server 112 generates the RFP and transmits to the client the RFP in an illustrative GUI 1100 in FIG. 11. GUI 1100 includes an RFP section 1102 and a vendor section 1104. RFP section 1102 includes the RFP, which may be further edited by the client. Server 112 generates RFP 1102 from RFP templates for the best practices and the data, including the attribute values, provided by the client. Vendor section 1104 includes a listing of approved vendors, community ratings of the approved vendors from other clients, and descriptions of the approved vendors. The approved vendors are those that have previously registered and gone through a review process with the EEM system. The client may select a community rating of an approved vendor to view specific ratings and feedbacks by other clients, similar to rating section 824 in FIG. 8.

The client may electronically submit the RFP to desired vendors by checking off the desired vendors and then selecting a send RFP button 1106. The client may also print the RFP to physically submit the RFP by selecting a print RFP button 1108.

Referring back to FIG. 3B, in block 358, assume server 112 receives from the client a request to electronically send the RFP to selected approved vendors as described above with respect to GUI 1100 in FIG. 11.

In block 360, server 112 transmits to the selected approved vendors the RFP.

Once an environmental impact or energy usage reduction plan starts, the client may provide progress information on the environmental impact or energy usage reduction plan and its procedures in the EEM software, including any actual figures on energy savings, cost impacts, and environmental impacts. The client may also provide ratings and feedbacks on the procedures and on the approved vendors. Server 112 provides the ratings and the feedbacks on the procedures via GUI 700 in FIG. 7 and GUI 800 in FIG. 8 as described above, and the ratings and the feedbacks on the vendors via GUI 1100 in FIG. 11 as described above.

In block 362, assume server 112 receives from the client progress information, a rating, and a feedback on an approved procedure, and a rating and a feedback on an approved vendor for the approved procedure.

In block 364, server 112 updates the completion ratio of the approved procedure in GUI 400 in FIG. 4 with the progress information. Server 112 also compares actual figures on the energy savings, cost impacts, and environmental impacts with the estimated results to adjust their calculations when necessary. This allows the EEM software to provide better estimation of the energy savings, the cost impacts, and the environmental impacts for the best practices. As more and more clients implement the same best practice, the EEM software uses their average savings to refine the savings estimates supplied to comparable organizations.

In block 366, server 112 saves the ratings and the feedbacks on the approved procedure and the approved vendor with other ratings and feedbacks.

In block 368, server 112 provides the ratings and feedbacks on the approved procedure and the approved vendor to any requesting client as described above with respect to GUI 700 in FIG. 7, GUI 800 in FIG. 8, and GUI 1100 in FIG. 11.

The client may create its own best practice and submit it for inclusion in the EEM software. The client may edit the best practice through a GUI 1200 generated by server 112. GUI 1200 allows the client to define parameters and inputs to the best practice, calculations to be performed on the parameters, outputs of the best practice. The inputs are the natural resources that will be affected (reduced or increased) by the best practice such as natural gas, electricity, etc. The parameters include attributes and parameter values of the organization to be provided by the client, such as square footage, number of lights, type of chiller, etc., and the set of common conversion factors from the environmental metric database 206 in FIG. 2.

Various other adaptations and combinations of features of the embodiments disclosed are within the scope of the invention. Numerous embodiments are encompassed by the following claims.

1. A method for assisting a client to reduce environmental impact or energy usage, comprising:
receiving a request to find recommendations for best practices for an organizational unit to reduce environmental impact or energy usage;
in response to receiving the request for to find recommendations for best practices for the organizational unit to reduce environmental impact or energy usage, selecting, using a processor, relevant best practices based on a goal of the organizational unit;
transmitting queries for relevant attribute values of the organizational unit based on the relevant best practices;
receiving the attribute value;
at least one of filtering and ranking the relevant best practices based on the attribute values to form recommended best practices; and
transmitting the recommended best practices.

2. The method of claim 1, wherein said selecting the relevant best practices is further based on an industry of the organizational unit, and the best practices are categorized by goals and industries.

3. The method of claim 1, wherein the goal is reducing emission of a greenhouse gas or production of a waste product.

4. The method of claim 1, wherein said filtering the relevant best practices comprises filtering the relevant best practices by presence of certain attribute values.

5. The method of claim 1, wherein said ranking the relevant best practices comprises ranking the relevant best practices by environmental impact reductions, payback periods, or total energy savings.

6. The method of claim 1, further comprising:
receiving a selection of a recommended best practice;
in response to receiving the selection of the recommended best practice, calculating estimated energy savings, cost impacts, and environmental impacts of the selected best practice based on one or more of the attribute values and default parameter values;
transmitting the estimated energy savings, cost impacts, and environmental impacts;
receiving updates to one or more of the attribute values and the default parameter values and a request to recalculate;
in response to the request to recalculate, recalculating the estimated energy savings, cost impacts, and environmental impacts based on the one or more updated attribute and parameter values; and
retransmitting the estimated energy savings, cost impacts, and environmental impacts.

7. The method of claim 6, wherein said calculating the estimated energy savings, cost impacts, and environmental impacts comprises using a set of common conversion factors for multiple clients including the client.

8. The method of claim 6, further comprising:
receiving a request to create a draft procedure from the selected best practice;
in response to receiving the request to create the draft procedure, adding the draft procedure to an environmental impact or energy usage reduction plan;
receiving a selection of the draft procedure;
in response to receiving the selection of the draft procedure, calculating a forecast of the estimated energy savings, cost impacts, and environmental impacts of the selected best practice over an implementation time period based on the attribute values and default parameter values;
transmitting the forecast of the estimated energy savings, costs impacts, and environmental impacts;
receiving updates to one or more of the attribute values and the default parameter values and a request to recalculate;
in response to the request to calculate, recalculating the forecast of the estimated energy saving, cost impacts, and environmental impacts based on the one or more updated attribute and parameter values; and
retransmitting the forecast of the estimated energy saving, cost impacts, and environmental impacts.

9. The method of claim 8, wherein said calculating the forecast of the estimated energy savings, cost impacts, and environmental impacts comprises using a set of common conversion factors for multiple clients including the client.

10. The method of claim 8, further comprising:
receiving a request to submit the draft procedure for approval;
in response to the request to submit the draft procedure for approval, changing the draft procedure to an awaiting approval procedure;
receiving an approval of the awaiting approval procedure; and
in response to the approval of the awaiting approval procedure, changing the awaiting approval procedure to an approved procedure.

11. The method of claim 10, wherein said receiving the request to submit the draft procedure for approval is from one user, and said receiving the approval of the awaiting approval procedure is from another user.

12. The method of claim 10, further comprising:
receiving actual energy savings, actual cost impacts, or actual environmental impacts on the approved procedure; and
using the actual energy savings, the actual cost impacts, or the actual environmental impacts to refine estimations of energy savings, costs impacts, or environmental impacts.

13. The method of claim 10, further comprising:
receiving a rating or a feedback on the approved procedure; and
providing the rating or the feedback on the approved procedure to other clients.

14. The method of claim 10, further comprising:
receiving a request to generate a request for proposal (RFP) including the approved procedure to a vendor;
in response to the request to generate the RFP, generating the RFP based on a template for a best practice from which the approved procedure is created; and
transmitting the RFP to the vendor.

15. The method of claim 14, further comprising:
receiving a rating or a feedback on the vendor; and
providing the rating or the feedback on the vendor to other clients.

16. The method of claim 1, further comprising:
comparing emission and energy usage data of organizational units against benchmarks to identify underperforming organizational units; and
transmitting a list of the underperforming organizational units.

17. The method of claim 10, further comprising:
receiving a selection of a combination of awaiting approval procedures, including the awaiting approval procedure, in the environmental impact or energy usage reduction plan;
transmitting a model of the energy savings, the cost impacts, and the environmental impact of the emission or energy usage reduction plan with the selected procedures; and
receiving an approval of the selected procedures for inclusion and execution in the environmental impact or energy usage reduction plan.

18. The method of claim 1, further comprising:
receiving assignments of authorized users for the organizational units; and
verifying a user from the client has proper authorization prior to transmitting any information to the user and saving any changes by the user.

19. The method of claim 1, further comprising:
maintaining an audit trail of changes made by users of the client to the client's account.

20. The method of claim 1, further comprising:
maintaining a set of common metrics in a database, wherein the energy savings, the cost impacts, and the environmental impacts are calculated based on the set of common metrics.

21. The method of claim 1, further comprising:
receiving a transmission of an organizational structure of the organization, the organization structure defining a hierarchical list of organizational units; and
receiving a transmission of demographic data and resource consumption data of the organizational units.
